(19) United States
(12) Patent Application Publication
(10) Pub. No.: US 2011/0304704 A1
(43) Pub. Date: Dec. 15, 2011

(54) Imaging Apparatus

(75) Inventor: Chen-Ping Yang, Taipei City (TW)

(73) Assignee: DIGILIFE TECHNOLOGIES CO., LTD., Taipei City (TW)

(21) Appl. No.: 12/797,097

(22) Filed: Jun. 9, 2010

(51) Int. Cl. H04N 5/225; H04N 13/00

(52) U.S. Cl. 348/48; 348/E05.025; 348/E13.014

(57) ABSTRACT

An imaging apparatus includes an audio/video capture mechanism having an audio/video processing unit, an image synchronization unit, a first imaging unit, a second imaging unit and a sound input/output unit; and an output mechanism movably installed on a side of the audio/video capture mechanism, and including a display unit installed on a surface of the output mechanism and coupled to the audio/video capture mechanism, and the second imaging unit is installed on another surface of the output mechanism, such that when the imaging apparatus is used for taking a picture, the first and second imaging units are used for capturing images from a same viewing angle, and the image synchronization unit is provided for synchronously combining the images to form a three-dimensional (3D) image, so as to achieve the effects of capturing and playing the 3D image.

### FIELD OF THE INVENTION

The present invention relates to an imaging apparatus, in particular to an imaging apparatus using first and second imaging units for capturing images from a same viewing angle respectively, and a synchronization unit for synchronously combining the images to form a three-dimensional (3D) image to achieve the effects of capturing and playing the 3D image.

### BACKGROUND OF THE INVENTION

In general, a conventional imaging apparatus is comprised a camera and a display installed at a side of the camera, and the display can be turned out from the side of the camera to capture or play desired video, and the display is provided for displaying the captured image and taking a picture, so as to achieve the photographic effect.

Since a general imaging apparatus comes with a design having only one lens, a user can produce two-dimensional (2D) images only, but not 3D images, while taking or playing the images. Obviously, the conventional imaging apparatus cannot meet user requirements.

Therefore, it is a main subject for the invention to provide an imaging apparatus capable of capturing and playing 3D images.

### SUMMARY OF THE INVENTION

In view of the shortcomings of the conventional imaging apparatus, the inventor of the present invention based on years of experience in the related industry to conduct extensive researches and experiments, and finally developed an imaging apparatus, in hope of achieving the effects of capturing and displaying 3D images.

Therefore, it is a primary objective of the present invention to provide an imaging apparatus that uses first and second imaging units to capture images from a same viewing angle, and an image synchronization unit to synchronously combine the images to form a 3D image, so as to achieve the effects of capturing and displaying the 3D image.

To achieve the foregoing objective, the present invention provides an imaging apparatus, comprising: an audio/video capture mechanism including an audio/video processing unit, an image synchronization unit, a first imaging unit, a second imaging unit and a sound input/output unit; and an output mechanism movably installed onto a side of the audio/video capture mechanism, and a display unit installed on a surface of the output mechanism and coupled to the audio/video capture mechanism, and the second imaging unit is installed onto another surface of the output mechanism.

In a preferred embodiment of the present invention, the audio/video processing unit, image synchronization unit, first imaging unit, second imaging unit and sound input/output unit of the audio/video capture mechanism are combined with a casing body, and the audio/video processing unit includes an audio/video processor, an operating interface, a power supply and a memory.

In a preferred embodiment of the present invention, each of the first and second imaging units includes a lens and a light sensing element, and the light sensing elements are disposed on a same image plane with an interval of 2 cm˜4 cm apart from each other.

In a preferred embodiment of the present invention, the output mechanism includes a casing, an axle installed at a side of the casing and coupled to the audio/video capture mechanism, a window portion formed on a surface of the casing, and the display unit corresponds to the window portion, and the display unit can be a touch panel or a liquid crystal display, and the second imaging unit is installed on another surface of the casing.

Therefore, the imaging apparatus of the present invention can use the first and second imaging units to capture images from a same viewing angle, and the image synchronization unit to synchronously combine the images to form a 3D image, so as to achieve the effects of capturing and displaying the 3D image.

### BRIEF DESCRIPTION OF THE DRAWINGS

FIG. 1 is an exploded view of a preferred embodiment of the present invention;

FIG. 2 is a perspective view of a preferred embodiment of the present invention; and

FIG. 3 is a schematic view of an application in accordance with a preferred embodiment of the present invention.

### DESCRIPTION OF THE PREFERRED EMBODIMENTS

The objects, characteristics and effects of the present invention will become apparent with the detailed description of the preferred embodiments and the illustration of related drawings as follows.

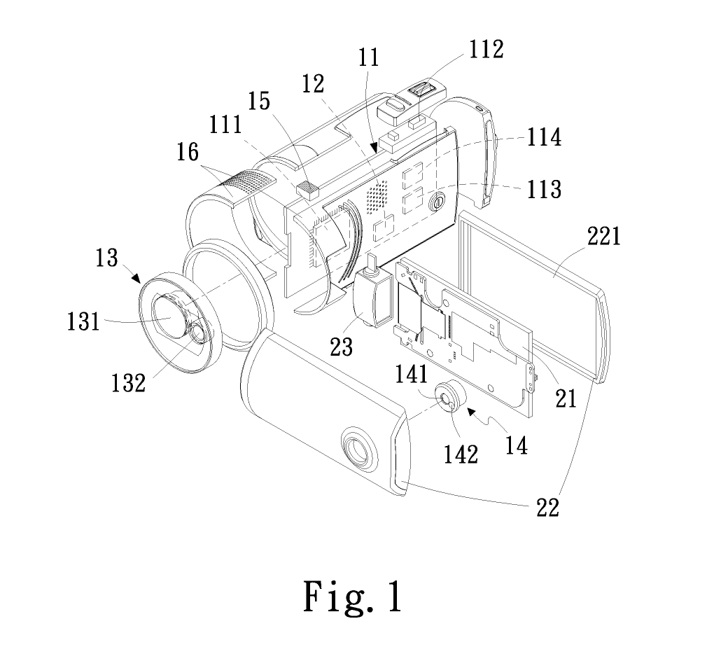

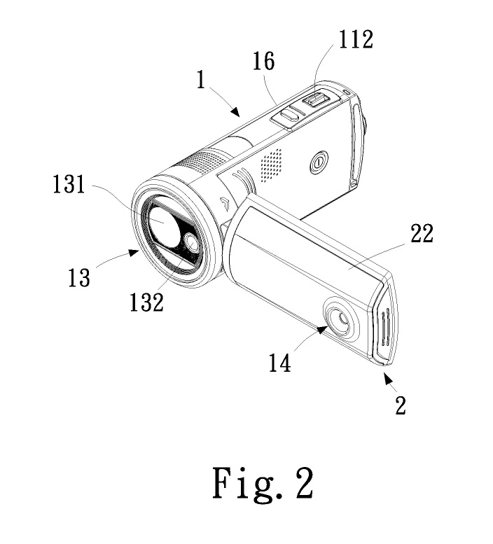

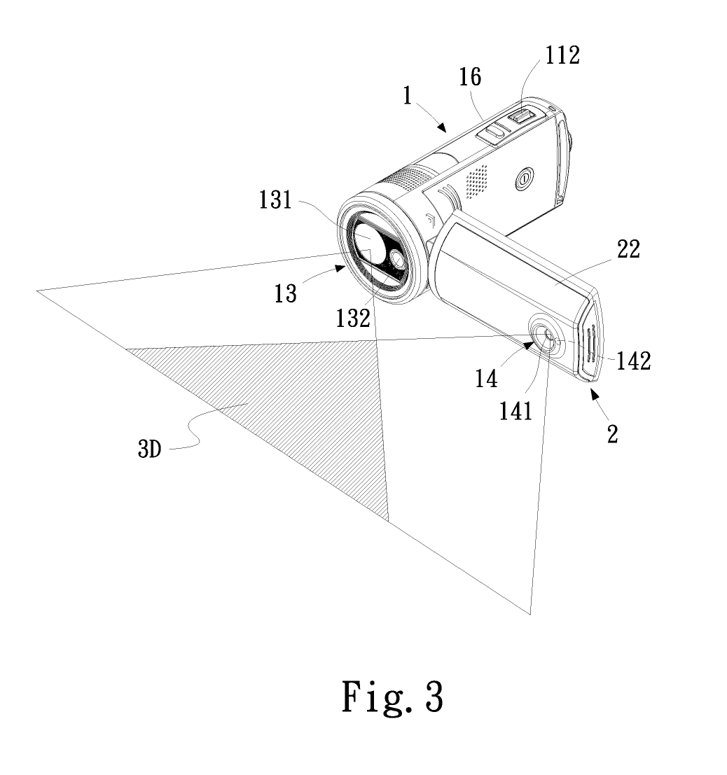

With reference to FIGS. 1 to 3 for an imaging apparatus of the present invention, the imaging apparatus is comprised of an audio/video capture mechanism 1 and an output mechanism 2.

The audio/video capture mechanism 1 includes an audio/video processing unit 11, an image synchronization unit 12 coupled to the audio/video processing unit 11, a first imaging unit 13 coupled to the audio/video processing unit 11, a second imaging unit 14 coupled to the audio/video processing unit 11, and a sound input/output unit 15 coupled to the audio/video processing unit 11, wherein the audio/video processing unit 11, image synchronization unit 12, first imaging unit 13, second imaging unit 14 and sound input/output unit 15 of the audio/video capture mechanism 1 are combined with a casing body 16, and the audio/video processing unit 11 includes an audio/video processor 111, an operating interface 112, a power supply 113 (such as a battery) and a memory 114, and each of the first and second imaging units 13, 14 includes a lens 131, 141 and a light sensing element 132, 142, and each light sensing element 132, 142 is disposed on the same image plane with an interval of 2 cm˜4 cm apart from each other.

The output mechanism 2 is movably installed at a side of the audio/video capture mechanism 1, and a display unit 21 is installed on a surface of the output mechanism 2 and coupled to the audio/video capture mechanism 1, and the second imaging unit 14 is installed on another surface of the output mechanism 1, wherein the output mechanism 2 includes a casing 22, an axle 23 installed at a side of the casing 22 and coupled to a casing body 16 of the audio/video capture mechanism 1, a window portion 221 formed on a surface of the casing 22, and the display unit 21 corresponds to the window portion 221, and the display unit 21 can be a touch panel or a liquid crystal display, and the second imaging unit 14 is installed on another surface of the casing 22.

When the present invention is applied, the output mechanism 2 is turned out from a side of the casing body 16 of the audio/video capture mechanism 1 by the axle 23 installed at a side of the casing 22 (and the output mechanism 2 can be turned over by using the axle 23, and the details will not be described further here), and the power supply 113 is provided for supplying the electric power required for the operation, and the audio/video processing unit 11 (including the audio/video processor 111, operating interface 112 and memory 114) together with the first imaging unit 13, second imaging unit 14, sound input/output unit 15 and image synchronization unit 12 are used for capturing and storing (or reading and playing) a desired video. When a picture is taken, images are captured by the lenses 131, 141 and the light sensing elements 132, 142 of the first and second imaging units 13, 14 respectively from a same viewing angle, and the image synchronization unit 12 is provided for synchronously combining the images to form a 3D image, and the 3D image is stored in the memory 114, so as to achieve the effects of capturing and playing the 3D image.

In summation of the description above, the present invention uses the first and second imaging units to capture images from a same viewing angle, and the image synchronization unit to synchronously combine the images to form a 3D image, so as to achieve the effects of capturing and displaying the 3D image, and the invention also complies with the patent application requirements, and products derived from the present invention can fully meet the present market requirements.

While the invention has been described by means of specific embodiments, numerous modifications and variations could be made thereto by those skilled in the art without departing from the scope and spirit of the invention set forth in the claims.

What is claimed is:

1. An imaging apparatus, comprising:
an audio/video capture mechanism, including an audio/video processing unit, an image synchronization unit coupled to the audio/video processing unit, a first imaging unit coupled to the audio/video processing unit, a second imaging unit coupled to the audio/video processing unit, and a sound input/output unit coupled to the audio/video processing unit; and
an output mechanism, movably installed at a side of the audio/video capture mechanism, and having a display unit installed on a surface of the output mechanism and coupled to the audio/video capture mechanism, and the second imaging unit being installed on another surface of the output mechanism.

2. The imaging apparatus of claim 1, wherein the audio/video processing unit, image synchronization unit, first imaging unit, second imaging unit and sound input/output unit of the audio/video capture mechanism are coupled to a casing body, and the audio/video processing unit includes an audio/video processor, an operating interface, a power supply and a memory.

3. The imaging apparatus of claim 1, wherein each of the first and second imaging units includes a lens and a light sensing element, and the light sensing elements are disposed on a same image plane, and separated by an interval of 2 cm to 4 cm apart from each other.

4. The imaging apparatus of claim 1, wherein the output mechanism includes a casing, an axle installed at a side of the casing and coupled to the audio/video capture mechanism, a window portion formed on a surface of the casing, and the display unit corresponds to the window portion, and the display unit is a touch panel or a liquid crystal display, and the second imaging unit is installed on another surface of the casing.
